(19) United States
(12) Patent Application Publication
(10) Pub. No.: US 2011/0079531 A1
(43) Pub. Date: Apr. 7, 2011

(54) PACKAGING FILM SECTION, PACKAGING FILM, PACKAGING AND PACKAGING-PRODUCT UNIT

(75) Inventors: Selcuk Yildirim, Zurich (CH); Jean-Claude Jammet, Neuhausen (CH)

(73) Assignee: AMCOR FLEXIBLES KREUZLINGEN LTD., Kreuzlingen (CH)

(21) Appl. No.: 12/937,028

(22) PCT Filed: Apr. 6, 2009
(86) PCT No.: PCT/EP09/02522

§ 371 Date: Dec. 2, 2010

(30) Foreign Application Priority Data
Apr. 11, 2008 (DE) 10 2008 018 629.5

(51) Int. Cl. B65D 73/00; B32B 3/14; B32B 3/02

(52) U.S. Cl. 206/471; 428/47; 428/78; 428/45; 428/56

(57) ABSTRACT

The invention concerns a packaging film, in particular for production of a packaging with at least one packaging film section comprising a single- or multi-layered substrate, a printed functional layer formed from a printable material forming at least in sections an outer layer of the packaging film section and structured such that it has antimicrobial and/or oxygen-scavenging properties. According to the invention it is provided that the section of the functional layer forming an outer layer of the packaging film section, or the functional layer forming the whole outer layer of the packaging film section, on an outside of the packaging film section is arranged at least in sections in an area surrounded by an annular sealing surface. Furthermore, the invention concerns a packaging and a packaging-product unit.

The invention concerns a packaging film, in particular for the production of a packaging, with at least one packaging film section, wherein the packaging film section comprises a single-layer or multi-layer substrate and a printed functional layer formed from a printable material, at least in sections forming an outer layer of the packaging film section, which is structured such that it has antimicrobial and/or oxygen-scavenging properties.

Furthermore the invention concerns a packaging, in particular a foodstuff packaging or a pharmaceutical packaging and a packaging-product unit, comprising at least one product packed in the packaging.

Coatings for foodstuff packaging are known which are used to protect the packed foodstuff from attack by micro-organisms such as bacteria, fungi or other germs. As WO 2006/133754 A1 discloses, there are two fundamentally different functional principles of antimicrobially active layers.

The first functional principle is characterised in that the antimicrobial active substances and inhibitors which are integrated in the layer are volatile and are released over time from the matrix material of the layer, whereby the antimicrobial effect occurs not only in the vicinity of the coated surface but also in the entire packaging volume.

The second functional principle is characterised in that the antimicrobial active substances and inhibitors in the functional layer are physically fixed such that they cannot autonomously escape from the carrier layer. The antimicrobial effect occurs in these functional layers only by direct contact of the packed product with the surface having the antimicrobial coating.

WO 2006/133754 A1 describes a progressive method with which a technical surface can be produced with a layer releasing antimicrobial active substances. A solution of polyvinylacetate, a conservation agent and a solvent is applied to the technical surface and dried on the technical surface to form an antimicrobially active layer.

As well as the functional layers described above with antimicrobial effect, functional layers are known in which chemical compounds are integrated that absorb and permanently bond oxygen chemically. Such chemical compounds are known as oxygen scavengers. Frequently the function of these scavengers is to produce and maintain an oxygen-free atmosphere in the packaging in order to guarantee extended conversation period of the packed product. To do this the direct compounds must firstly remove as quickly as possible the remaining oxygen in the packaging space, secondly the compounds—where integrated in the outer packaging material—constitute an active barrier to oxygen migrating into the packaging from the outside.

WO 2007/051860 A1 describes a novel lacquer material with oxygen-scavenging properties. This comprises a matrix consisting of organic polymers and at least one component which, after suitable triggering, is reactive to oxygen.

The functional layers previously described (antimicrobial layers/oxygen-scavenging layers) have proved successful in particular in foodstuff packaging and pharmaceutical packaging. However the integration of such functional layers in packaging material often entails difficulties, in particular if the functional layer, in order to achieve the desired effect, must have direct contact with the packed product and/or the packaging volume. To achieve this, the functional layer, as well as having antimicrobial and/or oxygen-scavenging properties, must be sealable in order to be able to enclose the packed product moisture-tight and/or air-tight. For non-sealable functional layers, the only possibility would be to coat these completely with a sealable layer, whereby any direct contact with the packed product would be lost and the functional effect of the functional layer at least reduced.

The invention is therefore based on the object of proposing a packaging film with a packaging film section comprising a functional layer with antimicrobial and/or oxygen-scavenging properties, which layer at least in sections forms an outer layer of the packaging film but nonetheless need not be sealable.

This object is achieved by a packaging film of the type described above in that the section of the functional layer with antimicrobial and/or oxygen-scavenging properties which forms an outer layer of the packaging film section, or the entire functional layer forming an outer layer of the packaging film section, is arranged on the outside of the packaging film section at least in parts, in an area enclosed by an annular sealing surface. The term ‘annular sealing surface’ means a sealing surface running in the peripheral direction about the area comprising the section of the functional layer forming the outer layer of the packaging film material or the functional layer forming the outer layer of the packaging film material, i.e. an endless sealing surface, the shape of which is not restricted to a particular geometric form. Thus, an annular sealing surface, as well as meaning a circular sealing surface, also means all other geometric shapes such as for example rectangular or square or oval ring forms.

With regard to the packaging, the object is achieved in that the packaging comprises at least one packaging film formed according to the concept of the invention.

With regard to the packaging-product unit, the object is achieved in that at least one product (packed product) is included in a packaging which has at least one packaging film formed according to the concept of the invention.

The invention is therefore based on the concept, for the case where the functional layer of the packaging film section only forms sections of an outer layer of the packaging film section, i.e. only extends to the outside edge of the packaging film section in parts in relation to its superficial extent, this section of the functional layer forming the outer layer of the packaging film section is arranged at least in parts, preferably completely, in an area which is surrounded on the outside (outer surface) of the packaging film section by an annular sealing surface i.e. running peripherally around the section. For the case where (in relation to its superficial extent) the entire functional layer reaches to the outside of the packaging section, i.e. the case that the functional layer forms completely an outer layer of the packaging film section, in a packaging film which is formed according to the concept of the invention it is provided that the functional layer is arranged at least partly and preferably completely in an area which on the outside (outer surface) of the packaging film section is surrounded by an annular sealing surface i.e, running peripherally around the area.

In other words, it is the core of the invention to form the outer surface of the packaging film section only partly using the entire functional layer or using a section of the functional layer, and to form at least a part area of the outer surface of the packaging film section with an annular sealing surface which is arranged such that it completely surrounds the section of the functional layer or the functional layer. Preferably, the sealing surface is formed by a sealable, in particular a hot sealable, material which, on a finished packaging formed using a packaging film formed according to the concept of the invention, forms a sealing seam which seals the packed product in particular air-tight and/or moisture-tight. It lies within the limits of the invention, as will be explained later, that the packaging film in the area of the annular sealing surface, for example to produce a bag-like packaging, is sealed to itself or another packaging part, in particular another packaging film, and thus surrounds the product, wherein the functional layer in this case preferably forms the packaging inside facing the (packed) product. A packaging film which is produced according to the concept of the invention essentially imposes lower requirements on the properties of the functional layer since the functional layer itself need not be sealed—the sealing function is performed, preferably exclusively, by the sealing surface surrounding i.e. running peripherally around the functional layer. Preferably, the functional layer is a non-sealable or at least only poorly sealable layer.

With regard to the structure of the single- or multi-layer substrate and the arrangement of the functional layer relative to the substrate, there are widely varying possibilities. It is for example possible for the substrate to comprise only a single layer, for example an aluminium layer. Alternatively, it is possible to provide as a substrate a multi-layer substrate which is constructed from different functional layers. Preferably, the functional layer is printed directly on the single- or multi-layer substrate. In the case of a multi-layer substrate the embodiment is preferred in which the layer immediately next to the functional layer is a primer layer which serves as an adhesion improving agent to guarantee a better attachment of the functional layer. An adhesion improvement can be achieved also by corresponding pre-treatment of the substrate, for example by plasma treatment. It lies within the limits of the invention to apply the primer layer shortly before printing the functional layer and hence making it part of the substrate for heating the functional layer.

In a refinement of the invention it is advantageously proposed that the outside/outer surface/flat side of the packaging film section, in an area outside the annular sealing surface, has no functional layer—the section of the functional layer forming the outer layer of the packaging film section, or the entire functional layer forming an outer layer, is therefore exclusively contained in the area enclosed by the annular sealing surface. In a packaging film which consists exclusively of a single packaging film section, it is advantageous if no functional layer is provided on the entire outside/outer surface of the packaging film in an area outside the area surrounded by the sealing surface, since this in particular non-sealable functional layer would be outside the actual product space.

With regard to the relative arrangement between the sealing surface and functional layer, there are various possibilities.

It is for example possible for the sealing surface to be formed by a sealing layer of the substrate which is covered in sections by the functional layer. In other words the functional layer of the packaging film section forming the outer layer of the packaging film section lies at least partly, and preferably completely, in a central area of the sealing layer so that the sealing layer, viewed from the outside of the packaging film, is visible only in an annular area surrounding the functional layer of the packaging film section. It is possible that the functional layer is printed directly onto the sealing layer. Alternatively, it is possible, between the functional layer and the sealing layer, to provide at least one further, preferably exclusively one further layer, preferably a primer layer as an adhesion improving agent.

In an alternative embodiment, the layer arrangement of the sealing surface and the functional layer are exchanged. Here the functional layer is printed onto the substrate, preferably onto a primer layer of the substrate, and the sealing surface is above (in the direction towards the outside) the functional layer, i.e. covers this in an annular fashion and thus encloses an inner section of the functional layer forming an outer layer of the packaging film section. Here it is however also conceivable for the sealing layer to be applied directly, preferably printed, onto the functional layer. Particularly preferred however is an embodiment in which the sealing layer is applied, in particular printed, on a suitable primer layer which is applied to the functional layer for adhesion improvement.

An embodiment is also possible in which both the sealing layer and the functional layer are applied to the substrate, preferably onto a corresponding adhesion-improving primer layer. For example, a first print roller can apply the functional layer in an inner area and a second print roller can apply the annular sealing surface about the functional layer. In this case the functional and sealing layers at least in essence do not overlap, they may join each other at places but could also have a planned print-free gap in between. The entire functional layer (i.e. the functional layer over its entire superficial extent) thus forms an outer layer of the packaging film section. To apply the sealing layer and the functional layer, it may be advantageous to harden the first layer which is applied (sealing layer or functional layer) before applying the second layer (functional layer or sealing layer) at least in part, for example by heat or radiation.

With regard to the geometric arrangement of the functional layer or section of the functional layer inside the annular sealing surface, there are again several possibilities. Thus it is possible, in order to provide a large surface arrangement of the functional layer or a section of the functional layer and hence achieve a contact area as large as possible, to apply the functional layer or section of the functional layer over the full surface inside the annular sealing surface, preferably such that the entire area which is surrounded by the annular sealing surface is filled by the functional layer. Alternatively, it is possible to arrange the functional layer only in at least one area inside the sealing surface, wherein the functional layer can be applied for example as a pattern, preferably as a regular pattern.

Also, an embodiment is possible in which the functional layer or section of the functional layer is formed from several layer part sections arranged next to each other, wherein at least two layer part sections of the functional layer or section of the functional layer have a different function. Thus for example antimicrobially active layer sections and oxygen-scavenging layer sections can be arranged within the annular sealing surface in a chequerboard pattern.

As explained initially, the material forming the functional layer (in particular material composition) is for example a printable material, which can be applied i.e. by at least one printing method, in particular onto the substrate and/or a sealing surface. For example, if digital printing methods are used, this can be formed as powder in the manner of a toner for laser printers. Particularly preferred however is a liquid design of material so that the material can be applied to the substrate for example by roller printing, flexography, ink jet printing, rotogravure or by correspondingly designed digital printing methods. The functional layer can also be applied for example by application by blade, brush or scraper, or sprayed or poured.

In a further refinement of the invention it is advantageously provided that the substrate is formed either as a barrier layer or comprises a barrier layer. Preferably, the barrier layer is a layer which is active in relation to avoiding oxygen diffusion in order to prevent the penetration of oxygen, such as oxygen from the surrounding air, into the packaging or through the substrate into the functional layer. It is particularly suitable here to form the barrier layer of aluminium or an aluminium alloy or use a barrier layer which at least contains aluminium,

Substrates which have a barrier layer can for example be foils containing at least one layer or a film of polyvinylchloride, ethylenevinyl alcohol, or containing at least one metallic layer or a vacuum vapour-deposited layer of silicon oxides or aluminium oxides. With regard to the antimicrobial effect, a barrier layer in the substrate is less critical and can in some cases be omitted.

With regard to the concrete structure of the non-sealable or only poorly sealable functional layer, there are widely varying possibilities. An embodiment is particularly preferred in which the functional layer is formed as described in WO 2006/133754 A1. WO 2006/133754 A1 shall, with regard to the structure of the functional layer, be considered duly disclosed as part of the disclosure content of the present application with the consequence that at least any one arbitrary feature of the present application can be combined with at least one arbitrary feature of WO 2006/133754 A1 and claimed as such. It is particularly preferred if the functional layer is formed such that it releases antimicrobially active substances such as for example benzoic acid, sorbic acid, natamycin, bacteriocin, plant extracts or their mixtures. Further active substances are silver, silver ions, quaternary ammonium compounds or quaternary phosphonium compounds. To achieve an antimicrobial effect, the functional layer can for example release antimicrobially active substances (release system). It is also possible for the functional layer to contain bonded or enclosed antimicrobially active compounds (contact toxicity). In addition the functional layer can form a biophobic and/or anti-adhesive surface.

Additionally or alternatively the functional layer, as stated initially, can be formed as an oxygen-scavenging layer with at least one chemical compound (scavenger) which is reactive to oxygen. Particularly preferably the functional layer is formed, at least in sections, as described in WO 2007/051860 A1. WO 2007/051860 A1 shall, with regard to a possible embodiment variant of the functional layer, be considered duly disclosed as part of the disclosure content of the present invention with the consequence that any arbitrary feature of the present application can be combined with at least one arbitrary feature of WO 2007/051860 A1 and claimed as such.

The functional layer for scavenging oxygen can contain for example anti-oxidants which themselves oxidise. Other substances are oxygen adsorbers which bind the oxygen by physical capture. Yet other functional methods are oxygen scavengers which chemically bind the oxygen. Further possibilities are catalytic reactions wherein oxygen constitutes at least one of the reagents.

As indicated initially, an embodiment of the packaging film can be produced in which this has only a single packaging film section previously described or is formed by a single packaging film section previously described. This is advantageous in particular if the packaging has only a single packed product space. Alternatively, the packaging film comprises several packaging film sections as described above which are arranged next to each other in particular in the transverse direction or longitudinal direction of the packaging film, wherein preferably at least two packaging film sections have an annular sealing surface, wherein preferably each annular sealing surface surrounds a section of the functional layer on the outside of the packaging film. It is possible and desirable for many applications that adjacent sealing surfaces merge into each other or form a common sealing surface, wherein then inside the entire sealing surface can be arranged several spaced functional layer sections of the packaging film which are surrounded by a common sealing surface. Preferably, the packaging film is separated from a large area packaging film, for example by cutting or punching, wherein the large area packaging film can be stacked for example in sheets or rolled on a roller.

The invention also leads to a packaging, in particular a foodstuff packaging or a pharmaceutical packaging, in particular for a medicament. The packaging is characterised in that this has at least one packaging film which is formed according to the concept of the invention or is formed from such a packaging film. In the simplest case the packaging consists of a single packaging film with a single packaging film section described above, the annular sealing surface of which is sealed to itself to form a bag-like packaging.

In a refinement of the invention it is advantageously provided that the functional layer forming an outer layer of the packaging film forms the inside of the packaging, i.e. is facing the packed product,

Particularly preferably, an embodiment of the packaging is formed as a blister pack, wherein the blister pack has a base film with cavities and a cover film. It is possible to form the base film and/or cover film with a packaging film which is formed according to the concept of the invention. Preferably, the functional layer or a section of the functional layer of a packaging film section of the packaging film forms a section of the inside of a closed cavity.

The invention also leads to a packaging-product unit wherein this has at least one (packed) product packed in a packaging previously described. The outer functional layer on the packaging faces towards the inside and hence towards the (packed) product. Particularly preferably, this is an embodiment in which the functional layer of a packaging film section of the packaging film has direct contact with the packed product, in particular in order to develop its antimicrobial effect to the full.

Further advantages, features and details of the invention arise from the description below of preferred embodiment examples and with reference to the drawings. These show:

FIG. 1 a packaging film with a single packaging film section comprising an annular sealing surface which surrounds an area in which is arranged an entire functional layer of the packaging film section or a section of the functional layer;

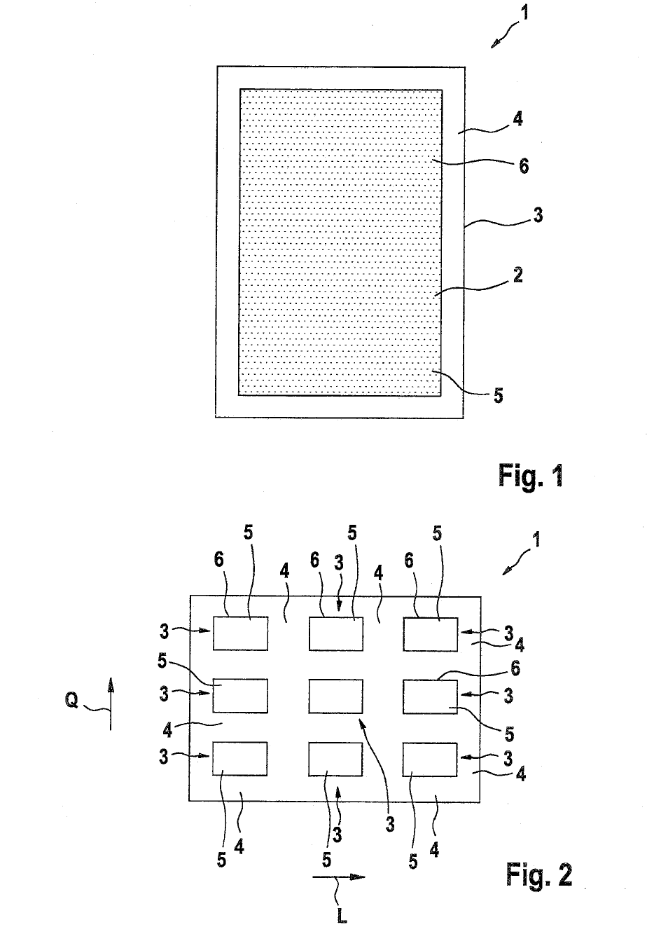

FIG. 2 an alternative embodiment example of a packaging film with several packaging film sections arranged next to each other in the longitudinal direction or transverse direction;

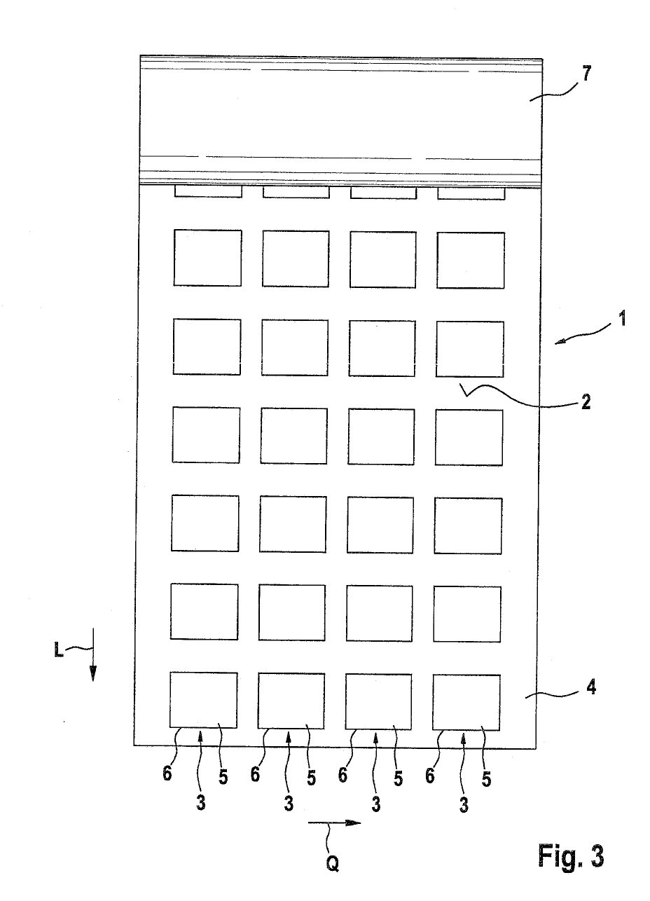

FIG. 3 a further alternative embodiment example of a packaging film with a multiplicity of packaging film sections, wherein the packaging film is rolled on a roller;

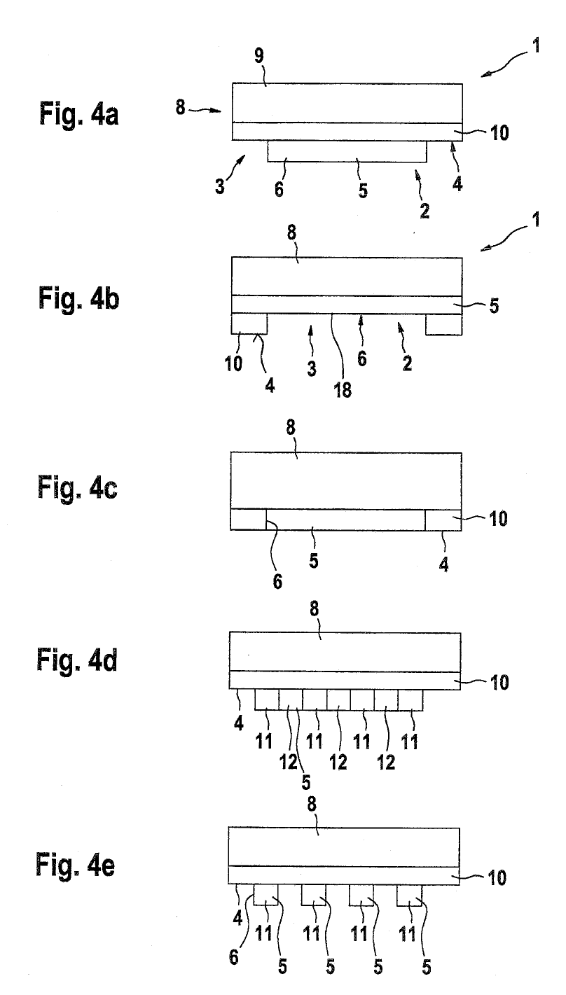

FIG. 4a a sectional view of a possible embodiment of a packaging film in which the functional layer is on a sealing layer and the entire functional layer of the packaging section is arranged inside an annular sealing surface formed by the packaging layer;

FIG. 4b a sectional view of an alternative embodiment of a packaging film in which the sealing layer is above the functional layer and a section of the functional layer is arranged inside an annular sealing surface which is formed by the sealing layer;

FIG. 4c a sectional view of a further alternative embodiment of a packaging film in which the entire functional layer of the packaging film section and the sealing layer are arranged in a plane next to each other;

FIG. 4d a sectional view of an alternative embodiment of a packaging film in which the functional layer forming an outer layer of the packaging film is formed from several functional layer sections arranged next to each other, wherein two types of functional layer sections are provided;

FIG. 4e a sectional view of a further alternative embodiment of a packaging film with a functional layer applied to a sealing layer, wherein the functional layer is not printed over the full surface but only in sections; and

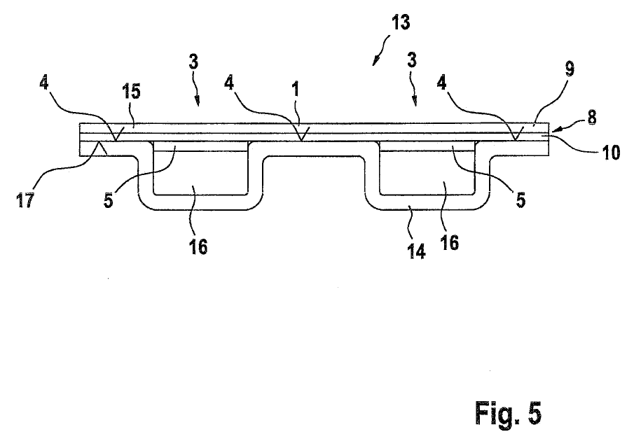

FIG. 5 a sectional view of a packaging formed as a blister pack with a packaging film formed as a cover film.

In the figures the same components and components with the same function carry the same reference numerals.

FIG. 1 shows a packaging film 1 in a view of the outside 2 formed on a flat side. The outside 2 of the packaging film 1 lying in the plane of the drawing can in sections form the inside of a packaging which is not shown in FIG. 1 and which can be produced using a packaging film 1. The thickness extent of the packaging film 1, i.e. the extent into the drawing plane, is preferably less than 1 mm.

The packaging film 1 shown in FIG. 1 is formed by a single packaging film section 3.

The outside 2 of the packaging film section 3 is partly formed by a rectangular, contoured, annular sealing surface 4 of a sealable material such as a sealing lacquer, a hot sealing lacquer, a sealing layer or a sealing film, of sealable material such as polyolefins e.g. polyethylene, polypropylene or their copolymers, or polyacryl or polymethacryl polymers or copolymers etc.

In an area inside the rectangular annular sealing surface 4, in a full surface application is a functional layer 5 printed on a substrate not shown and forming an outer layer of the packaging film section 3. This functional layer 5 has antimicrobial and/or oxygen-scavenging, i.e. oxygen binding, properties. In the finished packaging, the functional layer 5 forms the innermost layer adjacent to the packaging inner volume and, depending on structure and arrangement of the packed product, is either in direct contact with the packed product or in direct contact with the atmosphere surrounding the packed product. The functional layer 5 is a non-sealable layer which completely fills the entire area 6, which is rectangular in this embodiment, inside the annular sealing surface 4.

A packaging produced using the packaging film 1 is sealed in that the annular sealing surface 4 is sealed, in particular hot-sealed, to a counter surface of another packaging part, in particular another packaging film. In a very simple embodiment it is conceivable for example to fold the packaging film 1 in half such that the one half of the annular sealing surface 4 comes to lie on the other half, whereupon the sealing surface sections are sealed together.

FIG. 2 shows an alternative packaging film 1 which in total has nine packaging film sections 3, wherein the packaging film sections 3 are arranged evenly distributed next to each other in the longitudinal direction L and in the transverse direction Q of the packaging film 1. The packaging film 1 according to FIG. 1 can be formed for example by separation of a packaging film section 3 from a packaging film 1 according to FIG. 2. It is evident that each packaging film section 3 on an outside 2 comprises an annular sealing surface 4, wherein each annular sealing surface 4 surrounds an area 6 within which is arranged a functional layer 5 of the packaging section 3 concerned, or merely a section of this functional layer 5, wherein the functional layer 5 has oxygen-scavenging properties and/or antimicrobial properties.

As is further evident from FIG. 2, adjacent annular sealing surfaces 4 merge into each other or have common surface sections. In total, the annular sealing surfaces 4 form a matrix structure in which areas 6 are enclosed or which surround areas 6 which in the embodiment example shown are each completely, or alternatively only in sections, covered by a functional layer 5 or a section of the functional layer of the packaging film section concerned. A packaging film 1 shown in FIG. 2 serves for example as a cover film to seal a base film of a blister pack, wherein then the areas 6 with the functional layers 5 or sections of functional layers 5 seal cavities which are formed in the base film. The annular sealing surfaces 4 or the sealing matrix which is formed of sealable material serve to connect the packaging film 1 with the base film of the blister pack to be moisture-tight and air-tight.

It is also conceivable that the packaging film 1 according to FIG. 2 constitutes a packaging film sheet, from which packaging film units and at least one packaging film section 3, preferably with several packaging film sections 3, can be separated, in particular cut or punched out.

FIG. 3 shows a packaging film 1 which is partly unwound from a roll 7. The packaging film 1 according to FIG. 3 serves as the basis for production of packaging film units as shown for example in FIG. 1 or FIG. 2. The packaging film 1 according to FIG. 3 is formed similarly to that in FIG. 2 and has a multiplicity of packaging film sections 3 which are arranged next to each other in the longitudinal direction L (unwinding direction) and in the transverse direction Q, wherein each packaging film section 3 has an annular sealing surface 4, each of which encloses an area 6 with functional layer 5.

FIGS. 4a to 4e show various embodiments of cut packaging films 1 rotated by 90° in relation to the previous figures, wherein the packaging films 1 which are shown in FIGS. 1 to 3 can be designed similarly to the embodiment examples in FIGS. 4a to 4e. The packaging films 1 shown, for reasons of clarity, each comprise only one packaging film section 3, wherein evidently a multiplicity of such packaging film sections can be arranged next to each other.

The packaging film 1 according to FIG. 4a comprises a substrate 8 which in the embodiment example shown is formed from a barrier layer 9 of aluminium, on which is applied over the full surface a sealing layer 10 of a sealable material. If necessary, further layers are provided between the barrier layer 9 and the sealing layer 10. On the sealing layer 10 in a central area of a packaging film section 3 is a functional layer 5 of the packaging film section with antimicrobial properties or oxygen-scavenging properties, wherein the functional layer 5 is for example printed directly onto the sealing layer 10. Alternatively, between the sealing layer 10 and the functional layer 5 is provided at least one further layer, preferably exclusively one further layer, preferably a primer layer, intended for adhesion improvement, wherein it is particularly preferred if the area covered by this primer layer corresponds at least approximately to the area covered by the functional layer 5. The outside 2 of the packaging film 1 or packaging film section 3 is formed by an annular sealing surface 4 and the functional layer 5 on the outside of the packaging film section 3 is surrounded by the sealing area 4. The annular sealing surface 4 is formed from the part section of the sealing layer 10 which is not covered by the functional layer 5.

FIG. 4b shows an alternative embodiment example of a packaging film 1. The single- or multi-layer substrate 8 is shown on which the functional layer 5 is directly printed over the full surface, which in sections forms the outer layer of the packaging film section. A side of the substrate 8 facing the functional layer 5 can be formed for example by a primer layer with adhesion-improvement properties. The functional layer 5 in an edge section of the packaging film section 3 is covered by a sealing layer 10 which is applied in the form of a ring, and which on the outside forms the annular sealing layer 4 which surrounds an inner area 6 that in the embodiment example shown is formed over the full surface by a section 18 of the functional layer 5 forming an outer layer of the packaging film section 3. If we regard the outside 2 of the packaging film 1, as in the embodiment example in FIG. 4a, we have the image shown in FIG. 1. The edge section of the functional layer 5 which is covered by the sealing surface 4 does not form an outer but an inner layer of the packaging film section 3.

In the embodiment example according to FIG. 4c, the entire functional layer 5 and the annular sealing layer 10 lie in a common plane at least in sections. Both the functional layer 5 and the sealing layer 10 are printed on the substrate 8. Where applicable, below the sealing layer 10 and the functional layer 5, can be a different functional layers or a common functional layer, in particular a primer layer. Preferably the functional layer 5 of the packaging film section 3 and the sealing layer 10 of the packaging film section 3 are applied next to each other, where in particular in the digital printing method both layers 5, 10 can be applied together. As evident from FIG. 4c, the annular sealing surface 4 which is formed by the sealing layer 10 surrounds the area 6 which is filled completely by the entire functional layer 5 forming an outer layer of the packaging film section. The entire sealing layer 10 also forms an outer layer of the packaging film section 3.

The embodiment example according to FIG. 4d essentially corresponds to the embodiment example in FIG. 4a. The substrate 8 comprises a sealing layer 10 which is covered in a central area by a functional layer 5 of the packaging film section 3. In an area outside the functional layer 5 forming an outer layer, the sealing layer 10 forms an annular sealing surface 4 which surrounds the functional layer 5 and is thus part of an outer layer of the packaging film section 3. The functional layer 5 in turn is formed by functional layer part sections 11, 12 which are arranged next to each other, wherein for example the functional layer part sections 11 have an antimicrobial function and the functional layer part sections 12 have an oxygen-scavenging function. The structure of the functional layer 5 as shown in FIG. 4d and described above can be also produced in the embodiment examples according to FIGS. 4b and 4c.

In the embodiment example according to FIG. 4e, the substrate 8 comprises amongst others a sealing layer 10 which in an outer area forms an annular sealing surface 4 surrounding the area 6. In the area 6 is provided a functional layer 5 which is not applied to the sealing layer 10 over the full surface but as a pattern consisting of a multiplicity of spaced functional layer part sections 11. The embodiment variant which is shown in FIG. 4e of the functional layer 5 can be combined with any arbitrary packaging film variant 1 according to FIGS. 4a to 4c.

FIG. 5 shows a packaging 13 formed as a blister pack. This packaging 13 is formed from a base film 14 which can be formed of one or more layers. Preferably, the base film 14 comprises at least one aluminium-containing layer or is formed as an aluminium-containing layer. Sealed to the base film 14 is a cover film 15, wherein the cover film 15 is designed as a packaging film 1 which can be designed as described above. The packaging film 1 in the embodiment example shown comprises a multi-layer substrate 8 which as well as an outer barrier layer 9 has a sealing layer 10 applied to the full area on the barrier layer 9. The sealing layer 10 is covered in sections by functional layers 5 which are part of the packaging film sections 3. In the areas outside the functional layers 5, the sealing layer 10 forms annular sealing surfaces 4 which, like the functional layer 5, face the base film 14. The cover film 15 or the packaging film 1 is arranged such that the functional layers 5 directly limit the cavities 16 which are made in the base film 14 so that the functional layers 5 can have direct contact with a (packed) product, not shown, which is contained in the cavities 16. The sealing surfaces 4 lie directly on counter surfaces 17 of corresponding form in the base film 14 which limit the cavities 16 on the edge. The sealing surfaces 4 are sealed with these counter surfaces 17 preferably by hot sealing.

1. A packaging film, useful for producing a packaging with at least one packaging film section comprising a single- or multi-layer substrate, a functional layer formed of a printable material and forming at least in sections an outer layer of the packaging film section, the printed functional layer being structured to have antimicrobial and/or oxygen-scavenging properties, wherein a section of the functional layer forming an outer layer of the packaging film section or the functional layer forming the whole outer layer of the packaging film section on an outside of the packaging film section is arranged at least in part in an area surrounded by an annular sealing surface.

2. A packaging film according to claim 1, wherein the section of the functional layer forming an outer layer of the packaging film section or the functional layer forming the entire outer layer of the packaging film section on the outside of the packaging film section is arranged exclusively in an area surrounded by the annular sealing surface.

3. A packaging film according to claim 1 wherein the sealing surface is covered by a sealing layer of the substrate which is covered at least in sections by the functional layer.

4. A packaging film according to claim 1 wherein the sealing surface is formed by a sealing layer covering the functional layer in part.

5. A packaging film according to claim 1 wherein the sealing surface is formed by a sealing layer of the substrate or a sealing layer applied on the substrate, wherein the sealing layer does not overlap the functional layer and the functional layer does not overlap the sealing layer.

6. A packaging film according to claim 1 wherein the functional layer is applied inside the area surrounded by the annular sealing surface over the full surface of the area or in at least one section of the area.

7. A packaging film according to claim 1 wherein the functional layer is formed of different part layer sections arranged next to each other.

8. A packaging film according to claim 1 wherein the material forming the functional layer is powdery or liquid or both powdery and liquid.

9. A packaging film according to claim 1 wherein the functional layer is printed by digital printing, flexography, rotogravure or ink jet printing.

10. A packaging film according to claim 1 wherein the substrate is formed as a barrier layer.

11. A packaging film according to claim 1 wherein the functional layer has antimicrobial properties and is formed to release one or more antimicrobially active substances.

12. A packaging film according to claim 1 wherein the functional layer comprises at least one scavenger component which is reactive against oxygen.

13. A packaging film according to claim 1 wherein the packaging film comprises exclusively one packaging film section or several packaging film sections which are arranged next to each other.

14. A packaging comprising at least one packaging film according to claim 1.

15. A packaging according to claim 14, wherein the area which is surrounded by the annular sealing surface (4), together with the section of the functional layer forming an outer layer of the packaging film section or with the functional layer forming an outer layer of the packaging film section, forms a packaging interior.

16. A packaging according to claim 14 wherein the packaging is formed as a blister pack with a base film having at least one cavity and with a cover film which is sealed to the base film closing the cavity, and wherein the base film is formed by the packaging film.

17. A packaging according to claim 14 wherein the packaging is formed as a blister pack with a base film having at least one cavity and with a cover film sealed to the base film closing the cavity, and wherein the cover film is formed from the packaging film.

18. A packaging-product unit comprising at least one product packed in a packaging according to claim 14.

19. A packaging-product unit according to claim 18 wherein the functional layer forming an outer layer of the packaging film section or the section of the functional layer forming an outer layer of the packaging film section has direct contact with the product.
